(19) United States
(12) Patent Application Publication
(10) Pub. No.: US 2025/0243970 A1
(43) Pub. Date: Jul. 31, 2025

(54) RAIL SUPPORTING APPARATUS FOR SUPPORTING TUBULAR RAIL MEMBER FOR BOARDING SPORTS ON A BASE FRAME

(71) Applicant: Mattheus S. Rosas-Léon, Winnipeg (CA)

(72) Inventor: Mattheus S. Rosas-Léon, Winnipeg (CA)

(21) Appl. No.: 18/428,059

(22) Filed: Jan. 31, 2024

(51) Int. Cl. F16M 13/02

(52) U.S. Cl. CPC F16M 13/02

(57) ABSTRACT

A rail supporting apparatus mounts a tubular rail member onto a base frame to assembly a rail structure for use in boarding sports like snowboarding. The apparatus includes (i) a mounting plate with first fasteners apertures for fastening to an upright supporting surface of the base frame and (ii) one or more mounting flange extending transversely from the mounting plate with second fastener apertures for fastening to a bottom surface of the tubular rail member. The arrangements allows the ready construction of a rail structure with available materials including base members of dimensional lumber and rail members formed of various pipe material. The mounting flanges are sloped downwardly and inwardly towards one another to form a cradle receiving the rail member so that fasteners can be oriented radially of the rail member.

### FIELD OF THE INVENTION

The present invention relates to a supporting apparatus for the construction of a rail of the type used in boarding sports including snowboarding, wakeboarding and the like, and more particularly the present invention relates to a rail supporting apparatus for mounting a tubular rail member onto a base frame including wooden structures formed of dimensional lumber to form the rail.

### BACKGROUND

In various boarding sports including snowboarding, wakeboarding, and the like, it is common to use various terrain accessories such as rail structures and the like upon which the participants can do tricks such as sliding their board along the rail structure. In order to provide adequate support for the weight of a participant and their board jumping onto and off of the rail, as well as sliding along the rail, such rail structures are commonly formed using a metal railing member with legs welded onto the railing member to support the railing member spaced above the ground. The welded construction of such rail structures is expensive and inaccessible to participants wishing to practice tricks on rail structures in any environment of their choosing.

### SUMMARY OF THE INVENTION

According to one aspect of the invention there is provided a rail supporting apparatus for mounting a tubular rail member onto a base frame for use in boarding sports, the apparatus comprising:
(i) a mounting plate including first fasteners apertures formed therein so as to be arranged to fasten the mounting plate to an upright supporting surface of the base frame; and
(ii) at least one mounting flange extending transversely from the mounting plate and including a second fastener aperture therein so as to be arranged to fasten the mounting flange to a bottom surface of the tubular rail member;
(iii) wherein said at least one mounting flange is formed integrally with the mounting plate as a unitary body.

The arrangement of the rail supporting apparatus having a mounting plate and a mounting flange(s) transverse to the mounting plate with fastener apertures therein allows individuals to readily construct their own rail structure with readily available materials. More particularly, the base members can be constructed of dimensional lumber to which the mounting plate can be bolted, and the mounting flanges allow commercially available pipe to be bolted thereon to securely support the pipe spaced above the ground by the base members in an accessible and cost-effective manner.

Preferably said at least one mounting flange comprises two mounting flanges oriented transversely to one another, in which the two mounting flanges are spaced apart from one another.

When the two mounting flanges are supported at a top end of the mounting plate and have respective upper mounting surfaces for engaging the tubular rail member, preferably the upper mounting surfaces are sloped downwardly and inwardly towards one another such that an interior angle between the upper mounting surfaces is within the range of 100 to 160 degrees. More particularly, the upper mounting surfaces may be sloped downwardly and inwardly towards one another such that an interior angle between the upper mounting surfaces is within a range of 120 to 150 degrees.

Preferably each mounting flange is oriented at an angle relative to the mounting plate that is within a range of 80 to 100 degrees. In the illustrated embodiment, each mounting flange is oriented perpendicularly to the mounting plate.

When each mounting flange is joined to the mounting plate along a respective fold line, each mounting flange preferably protrudes outwardly from the mounting plate to an outer free edge that lies parallel to the respective fold line of the mounting flange.

The mounting plate may include a slot formed in an upper edge of the mounting plate at a location between the two mounting flanges such that an upper edge of the mounting plate between the two mounting flanges is recessed downwardly relative to the mounting flanges. In this instance, the inner end of the slot is formed with a radius of curvature.

In one embodiment, when the mounting plate includes two opposing side edges extending downwardly from an upper edge of the mounting plate locating the two mounting flanges thereon, the side edges preferably diverge away from one another such that an interior angle between the side edges is within a range of 50 to 100 degrees. More preferably, the interior angle between the side edges of the mounting plate is within a range of 65 to 85 degrees.

When the mounting plate includes two opposing side edges extending downwardly from an upper edge of the mounting plate locating the two mounting flanges thereon, the mounting plate preferably further includes two of the first fastener apertures associated with each side edge configurated such that for each side edge, an imaginary axis connected between the two first fastener apertures associated with the side edge is oriented transversely to that side edge.

When the mounting plate extends downwardly from an upper edge supporting the two mounting flanges thereon to an opposing bottom edge, the bottom edge may be form with two lobes diverging downwardly and outwardly from one another in which each lobe locates two of the first fastener apertures therein.

According to an alternative embodiment, when the mounting plate extends downwardly from an upper edge supporting the two mounting flanges thereon to an opposing bottom edge of the mounting plate, the mounting plate may further include two side edges extending upwardly from the bottom edge towards the upper edge along opposing sides and configured such that the side edges include (i) lower portions adjacent to the bottom edge which are parallel to one another and (ii) upper portions extending upwardly from the lower portions respectively to diverge away from one another.

According to a second aspect of the present invention there is provided a rail structure for use in boarding sports, the rail structure comprising:
(i) a tubular rail member;
(ii) at least one base member supporting a respective portion of the tubular rail member spaced above the ground; and
(iii) a rail supporting apparatus of the type described above coupling the tubular rail member to said at least one base member.

Preferably said at least one mounting flange is secured to the tubular rail member by a bolt oriented radially of the tubular rail member.

Preferably said at least one base member is constructed of dimensional lumber and the mounting plate is bolted to the dimensional lumber of the base member.

According to a third aspect of the present invention there is provided a method of constructing a rail structure for use in boarding sports, the method comprising:
(i) providing a tubular rail member; and
(ii) supporting a portion of the tubular rail member spaced above the ground on a base member by coupling the tubular rail member to the base member using a rail supporting apparatus of the type described above.

The method preferably includes the additional step of coupling said at least one mounting flange of the rail supporting apparatus to the tubular rail member using a bolt oriented radially of the tubular rail member.

The method may further include the additional step of constructing the base member of dimensional lumber and coupling the mounting plate to the dimensional lumber using at least one bolt.

### BRIEF DESCRIPTION OF THE DRAWINGS

Various embodiments of the invention will now be described in conjunction with the accompanying drawings in which:

FIG. 1 is a perspective view of a rail structure used in board sports such as snowboarding in which rail supporting apparatuses according to the present invention support a tubular rail member onto base frames formed of dimensional lumber to construct the rail according to a first embodiment of the rail supporting apparatus;

FIG. 2 is an enlarged perspective view of the rail structure illustrating one of the rail supporting apparatuses according to the first embodiment of FIG. 1;

FIG. 3 a perspective view of the rail supporting apparatus according to the first embodiment of FIG. 1;

FIG. 4 is a perspective view of a rail supporting apparatus according to a second embodiment;

FIG. 5 is a front elevational view of the rail supporting apparatus according to the first embodiment of FIG. 1;

FIG. 6 is a side elevational view of the rail supporting apparatus according to the first embodiment of FIG. 1;

FIG. 7 is a front elevational view of the rail supporting apparatus according to the second embodiment of FIG. 4; and

FIG. 8 is a side elevational view of the rail supporting apparatus according to the second embodiment of FIG. 4.

In the drawings like characters of reference indicate corresponding parts in the different figures.

### DETAILED DESCRIPTION

Referring to the accompanying figures there is illustrated a rail supporting apparatus generally indicated by reference numeral 10. The apparatus 10 is particularly suited to aid in the construction of a rail structure 12 of the type commonly used in boarding sports (for example snowboarding or wakeboarding and the like) in which a participant 14 of the sport rides on a board 16 (by strapped to the board or not) and maneuvers the board 16 to slide along the rail structure 12.

In the illustrated example, the rail structure 12 comprises a rail member 18 formed of a tubular pipe. It is most desired to use commercially available pipe, for example plastic plumbing pipe in the range of 6 to 8 inches in diameter; however other pipes formed of plastic or metal of varying diameter as little as 1 and ⅞ of an inch in diameter or of diameter greater than 8 inches is also feasible.

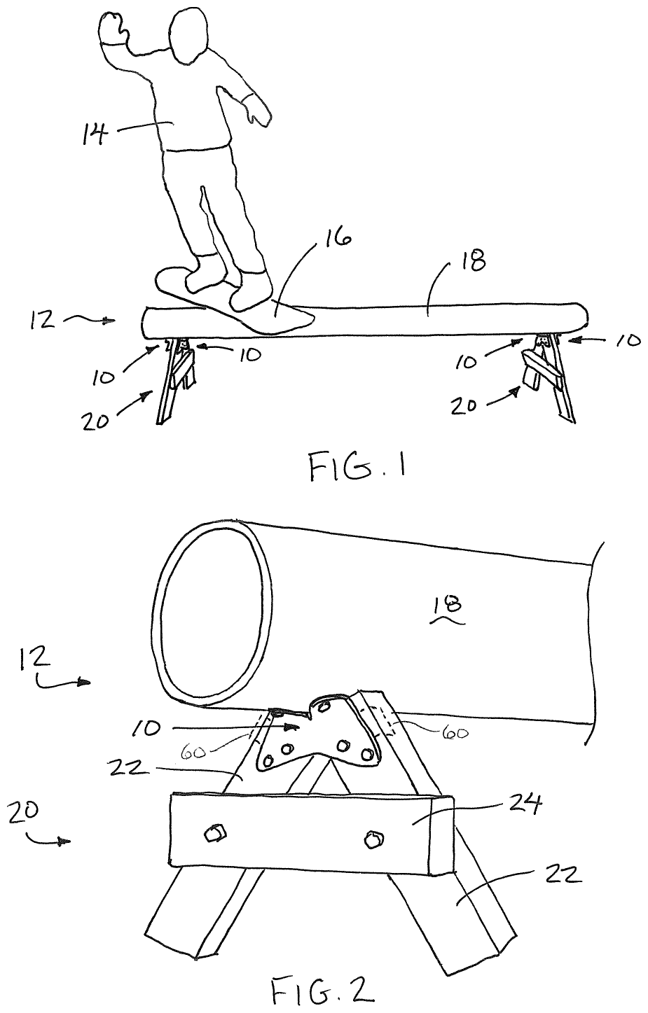

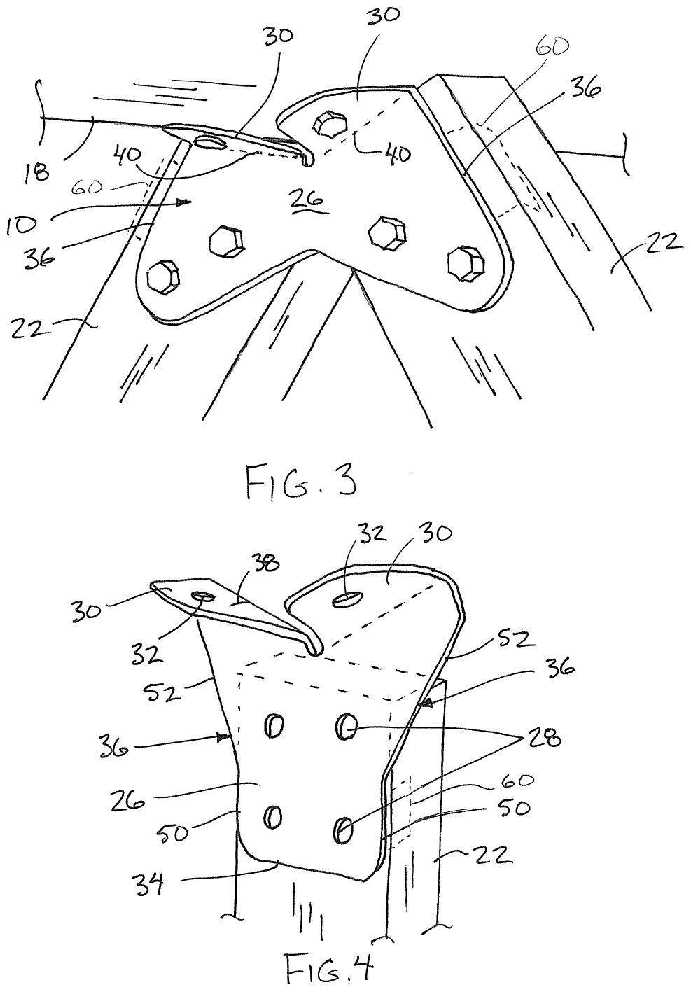

The rail member 18 of the rail structure 12 is supported spaced above the ground by one or more base members 20 of the rail structure. In the preferred embodiment of FIGS. 1 to 3, the base member is formed of dimensional lumber that is cut to form two legs 22 which diverge downwardly and laterally outwardly from one another from a top to a bottom of the base member, and a crossmember 24 fastened across the two legs 22 at an intermediate height generally in the form of the letter A using bolts extending through each leg and the crossmember respectively. The rail supporting apparatus 10 is bolted to the top ends of the legs at the top of the base member below to securely fix the legs 22 relative to one another and relative to the tubular rail member 18, as described in further detail. In preferred embodiments, two apparatuses 10 are mounted between each base member and the rail member at opposing ends of the base member in the longitudinal direction of the rail member.

Although various embodiments of the rail supporting apparatus 10 are shown in the accompanying figures, the common features will first be described. In each instance, the rail supporting apparatus 10 includes (i) a mounting plate 26 locating first fastener apertures 28 therein for fastening to the dimensional lumber of the base member 20, and (ii) two mounting flanges 30 protruding transversely from an upper edge of the mounting plate and locating respective second mounting apertures 32 therein for fastening to the outer boundary surface of the rail member 18. The mounting flanges are formed integrally with the mounting plate as a unitary body of common steel plate material that has been folded such that the mounting flanges are continuous and seamless relative to the mounting plate.

The mounting plate 26 is a flat rigid steel plate locating a plurality of the fastener apertures 28 therein. The fastener apertures 28 are arranged to receive bolts through the apertures for fastening the mounting plate to the dimensional lumber and more particularly for fastening the plate against an upright supporting surface of the legs 22 of the base member such that the plate is typically near vertical in orientation in a mounted position with the upper edge of the plate abutted against the bottom side of the rail member 18. The mounting plate 26 extends downward from the upper edge abutted against the rail member to an opposing bottom edge 34 of the mounting plate. The mounting plate 26 further includes two opposing side edges 36 at laterally opposing sides of the plate, spanning a height of the plate from the bottom edge 34 to the top edge abutted with the rail member 18.

The mounting flanges 32 in the illustrated embodiment extend perpendicularly outward of the plane of the mounting plate 26 at laterally spaced apart positions along the top edge of the mounting plate. Each mounting flange has an upper supporting surface 38 at the top side which faces upwardly and away from the bottom edge 34 of the mounting plate. The upper supporting surfaces receive respective portions of the bottom side of the rail member 18 engaged upon them in use. Locating the mounting flanges 30 to extend perpendicularly outward from the plate 26 is suited for applications where the rail member 18 is intended to be mounted perpendicularly to the vertical plane of the frame of the base member 20.

In other embodiments when the rail member is intended to be sloped relative to the ground or sloped relative to the legs of the base member in a longitudinal direction of the rail member, the mounting flanges 30 can instead protrude from the mounting plate in a non-perpendicular range of between 75 and 105 degrees, for example or more preferably through a narrower range of 80 to 100 degrees, or yet more preferably within a range of 85 to 95 degrees.

The upper supporting surfaces 38 of the mounting flanges which abut the bottom side of the rail member 18 are flat surfaces which are sloped downwardly and laterally inwardly towards one another in the mounted orientation of the apparatus 10. In this manner, each mounting flange is well suited to abut the circumference of the pipe forming the rail member so as to be tangential to the pipe or perpendicular to a radial axis of the pipe. The second fastener apertures 32 are centrally located within the mounting flanges 30 respectively to allow a bolt to be received therethrough for fastening the mounting flanges at circumferentially spaced positions through the boundary wall of the pipe forming the rail member 18. The bolts are aligned along radial axes of the rail member 18 such that the bolts are oriented perpendicularly to the circumferential boundary of the pipe.

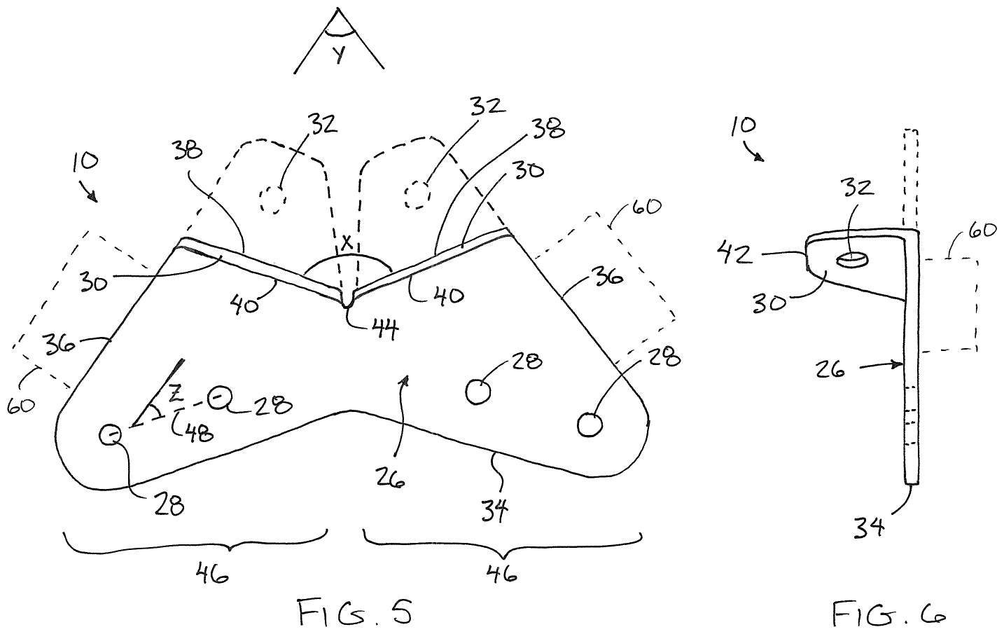

Each mounting flange 30 is formed by folding a blank steel plate which has been laser cut to the appropriate pattern such that each mounting flange 30 is joined to the mounting plate 26 along a respective fold line 40 along the upper edge of the plate which lies generally in a common plane with the mounting flange 30. The shape of blank before folding of the flanges 30 is represented in broken line in FIGS. 5 through 8.

Each mounting flange extends outward from the mounting plate from the fold line 40 to an outer free edge 42 of the flange that defines a flat edge lying parallel to the fold line 40 and parallel to the mounting plate 26. The fold lines 40 follow the same downward and laterally inward slope towards one another as the upper supporting surfaces 38 of the mounting flanges 30 to align the mounting flanges tangentially with the outer cylindrical surface of the rail member 18. The resulting interior angle X between the upper supporting surfaces of the mounting flanges is approximately 135 degrees in the illustrated embodiment; however, in further embodiments the angle X preferably lies in the range of 100 to 160 degrees, and more preferably in the range of 120 to 150 degrees.

A recessed slot 44 is formed in the upper edge of the mounting plate in alignment with the gap between the mounting flanges 30 such that the upper edge is recessed downwardly into the mounting plate below the elevation of the fold lines 40 of the mounting flanges 30 at the top of the plate. The inner end of the slot 44 is formed with a radius of curvature.

The first fastener apertures 28 in the mounting plate 26 and the second fastener apertures 32 in the mounting flanges 30 are typically sized to receive bolts having a diameter of ⅜ of an inch. This can be accomplished by sizing the holes with a diameter of 7/16 of an inch to allow clearance for coating of the parts. In further embodiments however different sizes of bolts can be used with different hole patterns being provided to receive the bolts. In each instance however bolts are used for securing the mounting plate to respective portions of the base member 20 and for securing the mounting flanges against the cylindrical boundary of the rail member 18. The fastener apertures 28 and 32 may also be a variety of different shapes including round holes, square holes, or elongated slotted holes with opposing parallel edges.

Turning now more particularly to the first embodiment shown in FIGS. 1 through 3, 5 and 6, in this instance the laterally opposing side edges 36 of the mounting plate are sloped so as to diverge downwardly and laterally outwardly away from one another from the top end to the bottom end of the plate in the mounted orientation. In this instance, the side edges 36 are oriented at an interior angle Y relative to one another which is approximately 75 degrees according to the illustrated embodiment. In further embodiments however the angle Y may be in the range of 50 to 100 degrees, and more preferably in the range of 60 to 90 degrees. In this instance, the side edges function as a guide to indicate the proper placement of the legs 22 relative to one another such that the legs extend downwardly and outwardly from the rail member 18 at an appropriate angle to provide the rail member with sufficient stability. Accordingly, when using the rail apparatus 10, the user aligns the longitudinal direction of the leg to extend parallel to the corresponding side edge 36 at both sides of the apparatus 10 to place the legs 22 at an appropriate diverging angle relative to one another. The legs 22 are mounted parallel to the side edges 36 respectively such that the mounting plate 26 is flush with or recessed relative to the corresponding outer side surface of the legs. In this manner, the apparatus 10 does not interfere with the mounting of a continuous wall member spanning longitudinally across the base member 20 along the length of the rail member 18.

According to the first embodiment, the bottom edge 34 of the mounting plate 26 is raised at a central location so that the bottom edge diverges downwardly and outwardly in opposing directions from the raised central portion, whereby the bottom edge defines two lobes 46 for alignment with the two legs 22 of the base member fastened thereto. Accordingly, each lobe 46 locates two of the first fastener apertures 28 therein for bolting the legs 22 to the lobes 46 respectively. The first fastener apertures 28 are located such that an imaginary axis 48 connected centre to centre between the first apertures within each lobe 46 lies transversely to the adjacent side edge 36 of that lobe so as to be angularly offset from one another by an angle Z of approximately 35 degrees according to the illustrated embodiment. In further embodiments, the angle Z may be in the range of 20 to 50 degrees. In this instance, the two fastener apertures 28 within each lobe are offset at different normal distances to the side edge 36 so as to be aligned with different portions of the wood grain of dimensional lumber that is aligned with the side edge 36. Locating the fastener apertures 28 laterally offset from one another relative to the dimensional lumber minimizes the likelihood of the lumber splitting.

Turning now to the second embodiment according to FIGS. 4, 7 and 8, the bottom edge 34 of the mounting plate 26 in this instance is a flat edge which is typically oriented horizontally in a normal mounted position. The side edges 36 in this instance include respective lower portions 50 extending upwardly from opposing ends of the bottom edge 34 in perpendicular relation to the bottom edge such that the lower portions 50 are parallel to one another at a lateral distance that is narrower than the overall width of the mounting flanges 30 at the top end of the mounting plate. More particularly, the width between the lower portions 50 is equal or less than the width of a 2×4 dimensional lumber such that the overall width may be 3 inches for example so as to be less than the typical 3.5″ width of a 2×4. The side edges 36 also include respective upper portions 52 extending upwardly from the lower portions 50 respectively such that the upper portions diverge upwardly and laterally outwardly from one another to the full width of the mounting flanges 30 at the top end of the mounting plate.

The first fastener apertures 28 in the mounting plate 26 according to the second embodiment are provided in a rectangular pattern of four holes at respective corners of the rectangular pattern.

The apparatus 10 according to the second embodiment is suited for use with a base member 20 comprised of a single leg 22 mounted as a vertical post of dimensional lumber mounted at its bottom end on a suitable structure to maintain the vertical orientation of the leg 22. Similarly to the previous embodiment, suitable bolts are extended through the first fastener apertures 28 to bolt the mounting plate against the upright supporting surface alongside the leg 22 forming a single post as shown in FIG. 4.

In yet further embodiments, the mounting flanges 30 may be replaced with a single mounting flange which is larger in size and locates plural fastener apertures therein which may be spaced apart form one another longitudinally or circumferentially of the rail member 18. In each instance, the basic form of the apparatus 10 including a mounting plate 26 and mounting flanges 30 is stackable by abutting the mounting plates 26 adjacent one another with the flanges 30 offset from one another so as not to interfere with stacking.

The fastener apertures in this instance or in any of the preceding embodiments may be slotted in a direction circumferentially of the rail member 18 to allow some adjustment with regard to placement of the bolts fastened through the mounting flanges 30. By forming the first fastener apertures 28 as slots that are elongated in the circumferential direction of the rail member, the bolts can more easily be aligned radially of the rail member 18 and perpendicularly to the cylindrical outer surface of the rail member.

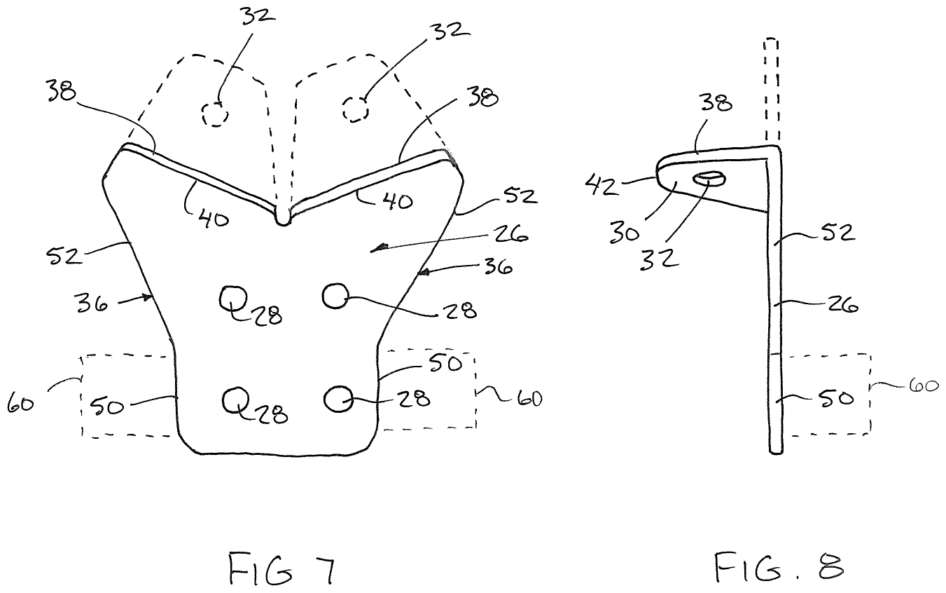

In some embodiments, each apparatus 10 may also be provided with an additional locating flange 60 shown in the figures in broken line. In each instance, the flanges 60 are cut from the same blank of metal plate material as a uniform body with the mounting plate 26 and the mounting flanges 30 as represented in FIGS. 5 and 7, followed by bending of the flanges to protrude perpendicularly from the mounting plate 26 in an opposing direction that the mounting flanges 30 protrude as best shown in FIGS. 6 and 8. The locating flanges 60 serve to abut corresponding outer side surfaces of the legs 22 of the base member upon which the apparatus 10 is mounted. To accomplish this, the flanges 60 are oriented (i) parallel to the sloped side edges 36 respectively in the first embodiment of FIGS. 1, 2, 3, 5, and 6, and (ii) parallel to the lower portions 50 of the side edges 36 in the second embodiment of FIGS. 4, 7 and 8. By abutting the locating flanges 60 against corresponding side surfaces of the legs, the apparatus 10 is placed at the proper orientation relative to the legs 22, while also providing reinforcement to securely fix the apparatus 10 immovably relative to the legs 22 in the assembled configuration of the rail structure.

In further embodiments, the general size and configuration of the mounting plate or the mounting flanges can be varied and the angles X, Y and Z described above can be varied for accommodating smaller diameter pipe rail members 18 or rail members that are oriented non-perpendicularly to the base members.

In yet further embodiments, the mounting flanges may be reinforced relative to the mounting plate by suitable gussets connected between the flanges and the mounting plate.

Although the illustrated embodiment is formed by laser cutting a blank from plate steel material followed by folding of the plate to form the mounting flanges 30, in further embodiments the rail apparatus 10 may be formed by other forming processes including stamp manufacturing, machining, casting, etc.

Since various modifications can be made in the invention as herein above described, and many apparently widely different embodiments of same made, it is intended that all matter contained in the accompanying specification shall be interpreted as illustrative only and not in a limiting sense.

1. A rail supporting apparatus for mounting a tubular rail member onto a base frame for use in boarding sports, the apparatus comprising:
a mounting plate including first fasteners apertures formed therein so as to be arranged to fasten the mounting plate to an upright supporting surface of the base frame; and
at least one mounting flange extending transversely from the mounting plate and including a second fastener aperture therein so as to be arranged to fasten the mounting flange to a bottom surface of the tubular rail member;
wherein said at least one mounting flange is formed integrally with the mounting plate as a unitary body.

2. The apparatus according claim 1 wherein said at least one mounting flange comprises two mounting flanges oriented transversely to one another.

3. The apparatus according claim 2 wherein the two mounting flanges are spaced apart from one another.

4. The apparatus according to claim 2 wherein the two mounting flanges are supported at a top end of the mounting plate and have respective upper mounting surfaces for engaging the tubular rail member in which the upper mounting surfaces are sloped downwardly and inwardly towards one another such that an interior angle between the upper mounting surfaces is within the range of 100 to 160 degrees.

5. The apparatus according to claim 2 wherein the two mounting flanges are supported at a top end of the mounting plate and have respective upper mounting surfaces for engaging the tubular rail member in which the upper mounting surfaces are sloped downwardly and inwardly towards one another such that an interior angle between the upper mounting surfaces is within a range of 120 to 150 degrees.

6. The apparatus according to claim 2 wherein each mounting flange is oriented at an angle relative to the mounting plate that is within a range of 80 to 100 degrees.

7. The apparatus according to claim 2 wherein each mounting flange is oriented perpendicularly to the mounting plate.

8. The apparatus according to claim 2 wherein each mounting flange is joined to the mounting plate along a respective fold line and wherein each mounting flange protrudes outwardly from the mounting plate to an outer free edge that lies parallel to the respective fold line of the mounting flange.

9. The apparatus according to claim 2 wherein the mounting plate includes a slot formed in an upper edge of the mounting plate at a location between the two mounting flanges such that an upper edge of the mounting plate between the two mounting flanges is recessed downwardly relative to the mounting flanges.

10. The apparatus according to claim 2 wherein the mounting plate includes two opposing side edges extending downwardly from an upper edge of the mounting plate locating the two mounting flanges thereon, the side edges diverging away from one another such that an interior angle between the side edges is within a range of 50 to 100 degrees.

11. The apparatus according to claim 10 wherein the interior angle between the side edges of the mounting plate is within a range of 65 to 85 degrees.

12. The apparatus according to claim 2 further comprising:
the mounting plate including two opposing side edges extending downwardly from an upper edge of the mounting plate locating the two mounting flanges thereon;
the mounting plate including two of the first fastener apertures associated with each side edge; and
for each side edge, an imaginary axis connected between the two first fastener apertures associated with the side edge being oriented transversely to that side edge.

13. The apparatus according to claim 2 wherein the mounting plate extends downwardly from an upper edge supporting the two mounting flanges thereon to an opposing bottom edge forming two lobes diverging downwardly and outwardly from one another, each lobe locating two of the first fastener apertures therein.

14. The apparatus according to claim 2 wherein the mounting plate extends downwardly from an upper edge supporting the two mounting flanges thereon to an opposing bottom edge of the mounting plate, the mounting plate including two side edges extending upwardly from the bottom edge towards the upper edge along opposing sides, the side edges including (i) lower portions adjacent to the bottom edge which are parallel to one another and (ii) upper portions extending upwardly from the lower portions respectively to diverge away from one another.

15. A rail structure for use in boarding sports, the rail structure comprising:
a tubular rail member;
at least one base member supporting a respective portion of the tubular rail member spaced above the ground; and
a rail supporting apparatus according to claim 1 coupling the tubular rail member to said at least one base member.

16. The rail structure according to claim 15 wherein said at least one mounting flange is secured to the tubular rail member by a bolt oriented radially of the tubular rail member.

17. The rail structure according to claim 15 wherein said at least one base member is constructed of dimensional lumber and the mounting plate is bolted to the dimensional lumber of the base member.

18. A method of constructing a rail structure for use in boarding sports, the method comprising:
providing a tubular rail member; and
supporting a portion of the tubular rail member spaced above the ground on a base member by coupling the tubular rail member to the base member using a rail supporting apparatus according to claim 1.

19. The method according to claim 18 including coupling said at least one mounting flange of the rail supporting apparatus to the tubular rail member using a bolt oriented radially of the tubular rail member.

20. The method according to claim 18 including constructing the base member of dimensional lumber and coupling the mounting plate to the dimensional lumber using at least one bolt.
